(19) United States
(12) Patent Application Publication
(10) Pub. No.: US 2010/0175440 A1
(43) Pub. Date: Jul. 15, 2010

(54) LOCKABLE PIN-TYPE LOCK FOR SLIDING DOORS

(75) Inventor: Jürgen Zinn, Heiligenhaus (DE)

Correspondence Address: HARNESS, DICKEY & PIERCE, P.L.C., P.O. BOX 828, BLOOMFIELD HILLS, MI, 48303, US

(73) Assignee: STEINBACH & VOLLMANN GmbH & Co. KG, Heiligenhaus (DE)

(21) Appl. No.: 12/377,243

(22) PCT Filed: Aug. 16, 2007
(86) PCT No.: PCT/EP07/07225

§ 371 Date: Feb. 11, 2009

(30) Foreign Application Priority Data
Aug. 16, 2006 (DE) 20 2006 012 565.5

(51) Int. Cl. E05B 65/08

(52) U.S. Cl. 70/100

(57) ABSTRACT

The invention relates to a lockable pin-type lock (1) for sliding doors, with a cylindrical housing (3) which can be fastened in the door leaf, and with a two-part locking pin (2) which can be displaced in the axial direction in the housing (3). In order to provide a lockable pin-type lock for sliding doors, which both permits a temperature-independent handling of the pin-type lock and also is simple to operate, it is proposed by the invention that the locking pin is formed from two parts, wherein the two parts of the locking pin can be displaced relative to each other in order to form an intermediate space.

The present invention relates to a lockable pin-type lock for sliding doors, in particular for sliding doors of cold stores.

Such pin-type locks are known in prior art and are mounted in the door leaf of a sliding door. They are composed of a cylindrical locking pin which is supported for displacement inside a cylindrical housing, and of a profile cylinder which is accommodated in this locking pin.

For locking the sliding door, the locking pin is manually pushed mechanically through the cylindrical housing from the “outer” side, which is the external side with respect to the lockable room, towards the “inner” side, which is the internal side with respect to the lockable room, whereupon the locking pin leaves from inside the door leaf and locks against the inner side of the door frame in the opening direction. The two positions of the locking pin, “open” and “closed”, can be locked through a key inserted in the profile cylinder and can be transferred from one to the other only as the key is turned, thus providing a workable and simple way of locking sliding doors.

German utility model DE 201 20 235 U1 describes a pin-type lock in which a locking pin carries a locking cam adapted to plunge into two tangential recesses of the housing, thus locking the positions “open” and “closed”. The longitudinal movement of the locking pin in the cylindrical housing is limited by an axially extending long hole in the housing, in which long hole a cylinder head bolt screwed to the locking pin is guided, and a rotation of the locking pin in the housing is prevented at the same time.

A disadvantage of the above-mentioned locking mechanisms is that the lockable pin-type lock forms a temperature bridge. If these pin-type locks are used in cold stores, the part of the locking pin which projects into the cold room extremely cools down. Through the locking pin forming a cold bridge the cold is conducted to the outside where water steam contained in the air will become condensed on and in the part of the locking pin which is situated on the outside and which contains the profile cylinder. The thus produced condensate freezes on and in the cold locking pin, thus preventing the pin-type lock from being used as intended, which can be a problem especially when the sliding door must be opened in case of an emergency.

The invention is therefore based on the object of providing a lockable pin-type lock for sliding doors, which both permits a temperature-independent handling of the pin-type lock and also is simple to operate.

In accordance with the present invention this object is achieved by a lockable pin-type lock as defined in claim 1, according to which the locking pin comprises two parts which can be displaced relative to each other to form a thermally insulating intermediate space. The independent claims relate to individual embodiments of the pin-type lock according to the present invention.

The lockable pin-type lock according to the present invention consists of a two-part cylindrical housing which is composed of an inner housing part, which is situated on the inside with respect to the lockable room, and of an outer housing part, which is situated on the outside with respect to the lockable room, and of a two-part locking pin supported for displacement in this cylindrical housing, with the inner part of the locking pin being coupled to a disk provided between the two parts of the locking pin. According to an alternative embodiment, the inner part of the locking can also be coupled to a screw.

In the following description the terms “inside” and “outside” still relate to the lockable room.

The two parts of the locking pin can be displaced relative to each other in the axial direction to thus allow forming a thermally insulated intermediate space interrupting the temperature bridge between the interior and the exterior of the lockable room. This successfully prevents disruption of the operation of the lockable pin-type lock caused by freezing condensate and permits the handling of the pin-type lock independently of a temperature difference.

A first advantageous embodiment of the invention provides housing parts in which the radius of the inner housing part is smaller than that of the outer housing part. The two housing parts are then inserted in the door leaf of the sliding door from inside respectively outside and are then rigidly connected to each other. This connection can be accomplished by screwing, bonding or in any other expedient way.

According to a further advantageous embodiment of the invention a small plate is attached to the outer periphery of the outer housing part as a safeguard against rotation. This small plate can be fixed by screwing, bonding or welding.

Preferably the housing is designed for telescoping to advantageously allow an adjustment to door leafs of a different thickness. This telescoping adjustment advantageously permits a vast range of adjustment to different door thicknesses alone by telescoping the two housing parts into each other, said housing parts including correspondent locking devices, for example in the form of partial threads, so that a simple rotation of the two housing parts relative to each other for example by 45° to 135° provides for a force-transmitting connection between the two housing parts. Accordingly, the housing is easy to mount by rotating the two housing parts in and relative to each other.

According to a further advantageous development of the invention the outer part of the locking pin includes a handle by means of which the outer part of the locking pin can be grasped to separate the two parts of the locking pin and can then be pulled outwards. The handle is designed so as to guarantee simple handling even in case the operator wears gloves which affect fine motor manipulations and thus make the handling more difficult. The handle can be in the form of a recess, a handhold such as a knob for example, or in any other expedient form.

According to an alternative embodiment of the invention a handle can even be dispensed with. In this case a key to be inserted in the profile cylinder is used for operation.

A further advantageous embodiment according to a first alternative of the invention provides that the inner part of the locking pin is lockable in the closing position. For this purpose a garter spring is situated between a conical surface on the outer end of the inner part of the locking pin and the inner surface of a disk provided between the two parts of the locking pin, said garter spring, for locking the inner part of the locking pin, engaging in a groove on the inner periphery of the outer housing part. The disk and the inner part of the locking pin are coupled to each other by a mushroom-shaped pin rigidly connected to the disk. The mushroom-shaped pin attached to the inner side of the disk centrally passes through the inner part of the locking pin in a cylindrical bore that is provided for this purpose and that has a greater radius on the inner end of the inner part of the locking pin in order to form a shoulder and to accommodate the mushroom head. Between this shoulder and the mushroom head a pressure spring is inserted pressing the mushroom head of the pin inwards with respect to the inner locking pin, resulting in the disk being pressed against the outer separation plane of the inner locking pin. Thus the garter spring, which has a smaller radius in the free condition, is expanded to enlarge the radius, whereupon the groove in the outer housing part can be engaged. To release the thus locked inner part of the locking pin, the mushroom head now serving as an operating element is pushed from the interior of the lockable room, so that the disk and the inner part of the locking pin become separated to from a small gap for accommodating the relaxing garter spring, whereby the groove in the outer housing part is cleared and the inner part of the locking pin becomes displaceable. The advantage of this mechanism is that an emergency opening from the interior of the lockable room is given on one side and prevention of burglary through the sealing gap of the sliding door on the other side.

Alternatively, a lock bolt can be provided as a locking element. The lock bolt is arranged for displacement transversely to the locking pin and/or to an operating element. Locking takes place through this bolt which can also be referred to as catch bolt.

The operating element can be designed as a mushroom head as described, a ball, cylinder, or in any other expedient way.

In a further embodiment according to the invention a coupling element is attached to the outer side of the disk and permits coupling the outer part of the locking pin to the disk and thus to the inner part of the locking pin. For this purpose a recess for accommodating the coupling element is provided in the outer part of the locking pin. The coupling itself is accomplished by turning the key in the profile cylinder, whereby a cam captures the coupling element. Now, if in this coupled state the handle of the outer part of the locking part is pulled, the pressure spring between the operating element and the shoulder on the cylindrical bore of the inner part of the locking pin is compressed, a small gap is produced between the disk and the inner part of the locking pin, and the locking of the inner part of the locking pin is released, thus allowing the lock to be opened.

The coupling element can be designed as a mushroom-like appendix, a hook-like appendix or in any other expedient way. For simple operation of the locking mechanism, which is effected by turning the key in the profile cylinder, a further advantageous embodiment of the invention provides for arranging the coupling element eccentrically on the disk to achieve a larger angle of rotation.

A further advantageous embodiment of the invention provides for guide elements on the disk and on the outer part of the locking pin as a safeguard against rotation of the disk and the outer part of the locking pin, which elements are guided in a longitudinally extending groove of the housing. This simultaneously limits the ability of axial displacement of the locking pin in the housing.

The guide elements can be in the form of a screw, a pin or in any other suitable form.

A further advantageous embodiment of the invention provides for a clamping device on the outer part of the locking pin, which clamping device engages in a recess on the housing part inner periphery lying on the outside. Thus the dimension of a determined, suitable insulation volume is ensured after locking the sliding door.

According to a preferred embodiment of the invention the clamping device is designed as a clamping member that can be concealed in the radial direction in the outer part of the locking pin, the clamping element being urged radially outwards by a pressure spring situated in the outer part of the locking pin. But the clamping device can also be constructed in any other useful form.

A further advantageous embodiment of the invention provides for bulged portions on both parts of the locking pin. The bulged portions are supported on one side on a shoulder in the outer housing part and on the other side on the inner periphery of the inner housing part, thus additionally limiting the ability of axial displacement of the locking pin and hence preventing jamming of the locking pin.

The bulged portions can be formed as a continuous bead, as welding spots, screws, pins or in any other expedient way.

A further advantageous embodiment of the invention provides for a groove on the inner periphery of the inner part of the locking pin. A packing can be inserted in the groove. This packing seals the lockable pin-type lock in a gastight fashion, so that no gas can penetrate from the interior of the lockable room into the pin-type lock, which would result in the formation of ice in the housing and in disrupting the operation of the pin-type lock. The packing can be in the form of an O-ring.

A further advantageous embodiment of the invention provides that both the inner part of the locking pin and the outer housing part can vary in their axial lengths to meet the different thicknesses of the sliding doors.

It should be understood that the lockable pin-type lock is not limited to its use in cold stores and that various embodiments of the invention are possible.

According to an alternative embodiment of the invention it can be provided for example that the inner coupling of the two parts of the locking pin is accomplished using a long screw which is appropriately positioned and countered. According to this embodiment the locking is effected through a catch which is seated crosswise in the locking pin, i.e. through a lock bar serving as a locking element. The locking by means of a disk and a garter spring does not apply in this second embodiment. The second embodiment is preferred to the first embodiment, because it is more simple to operate and less vulnerable to failures.

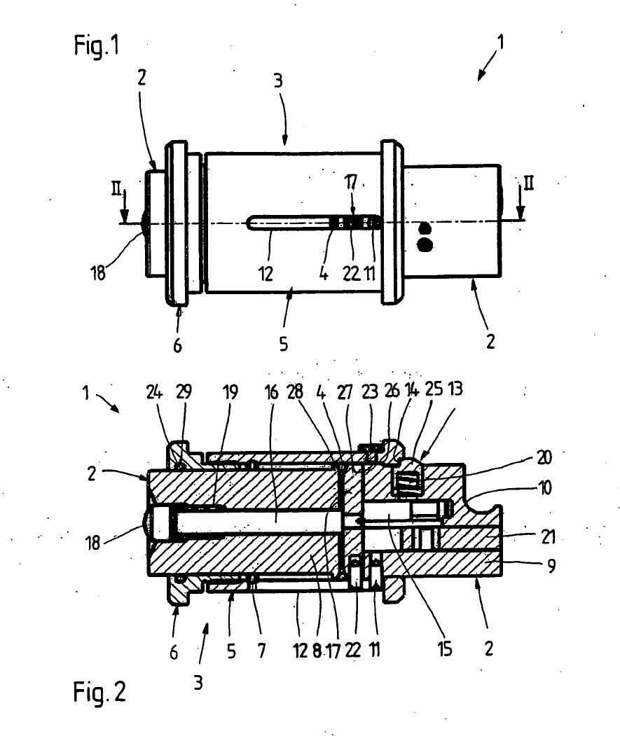

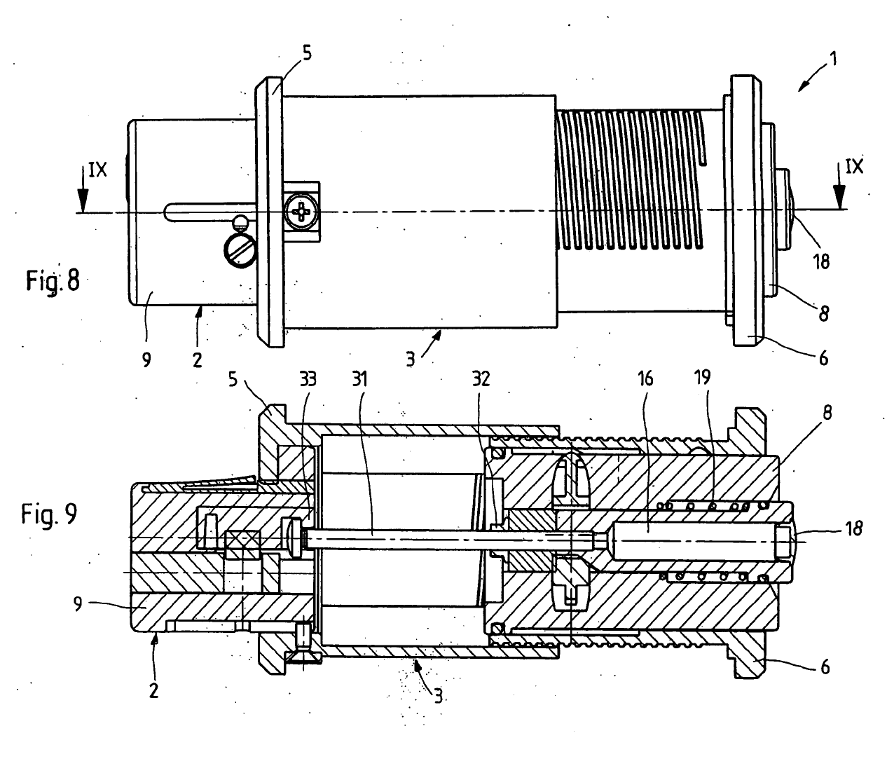

To better understand the operation of the lockable pin-type lock, one embodiment will be described by way of example in the following on the basis of the FIGS. 1 to 7. An alternative embodiment is illustrated in the FIGS. 8 to 14. In the drawings it is shown by

FIG. 1 a lateral view of the lockable pin-type lock according to a first embodiment, in an unlocking position;

FIG. 2 a cross section of the lockable pin-type lock according to a first embodiment, in an unlocking position and in the longitudinal direction;

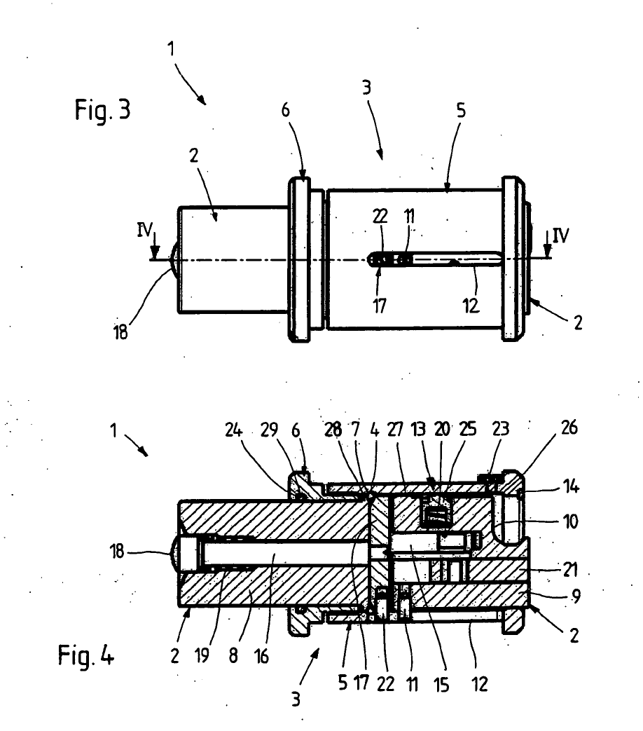

FIG. 3 a lateral view of the lockable pin-type lock according to a first embodiment, in a locking position;

FIG. 4 a cross section of the lockable pin-type lock according to a first embodiment, in a locking position and in the longitudinal direction;

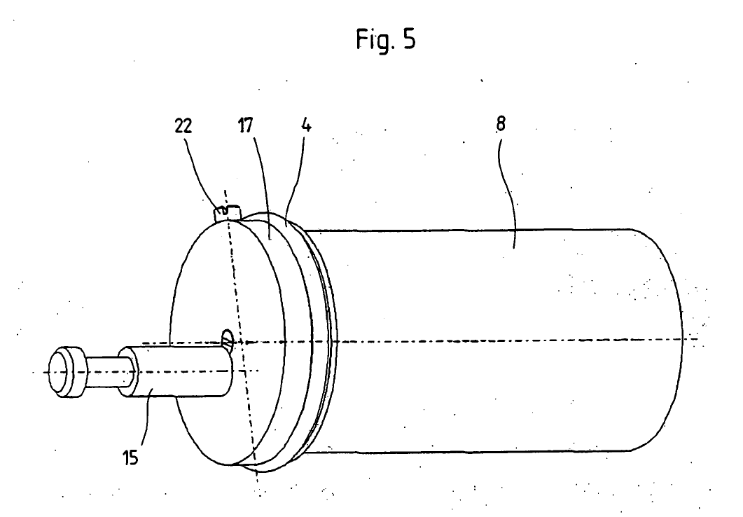

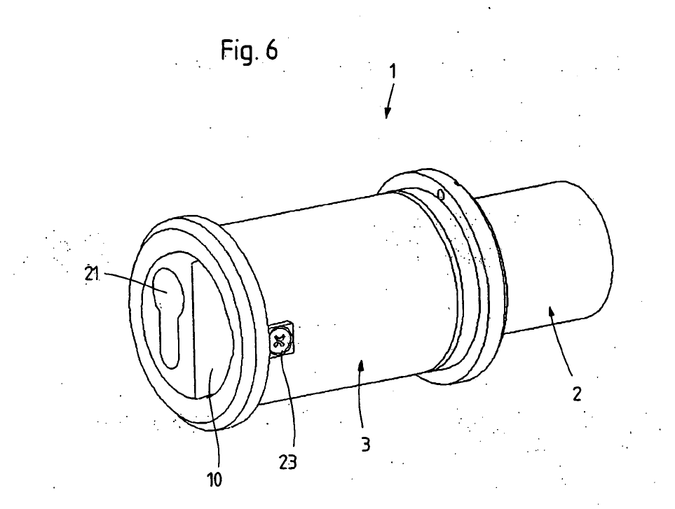

FIG. 5 the inner locking pin including an eccentrically arranged coupling element according to a first embodiment;

FIG. 6 the lockable pin-type lock according to a first embodiment, in a locking position and comprising small plates against rotation;

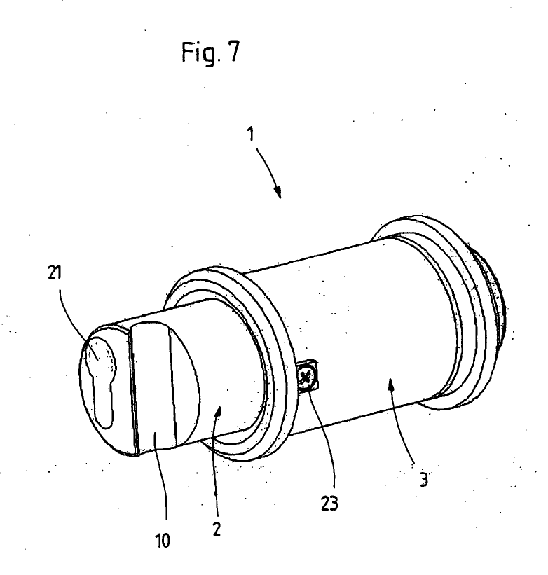

FIG. 7 the lockable pin-type lock according to a first embodiment, in an unlocking position and comprising small plates against rotation;

FIG. 8 a view of the pin-type lock of the invention according to a second embodiment;

FIG. 9 a sectional view of the pin-type lock according to FIG. 8, along line IX-IX;

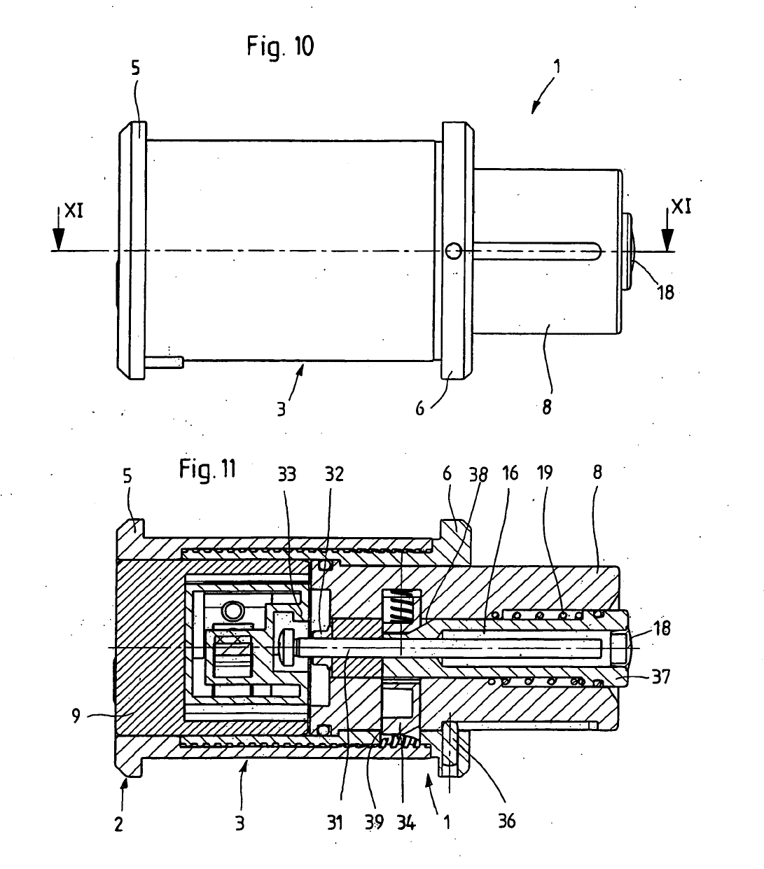

FIG. 10 a view of the pin-type lock of the invention according to a second embodiment;

FIG. 11 a sectional view of the pin-type lock according to FIG. 10, along line XI-XI;

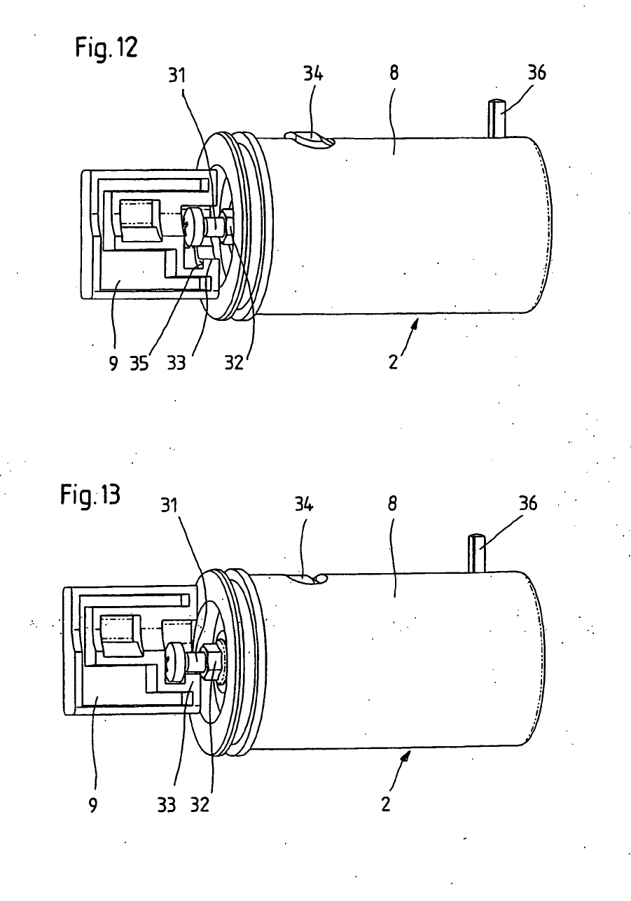

FIG. 12 a first view of the locking pin of the pin-type lock according to a second embodiment;

FIG. 13 a second view of the locking pin of the pin-type lock according to a second embodiment;

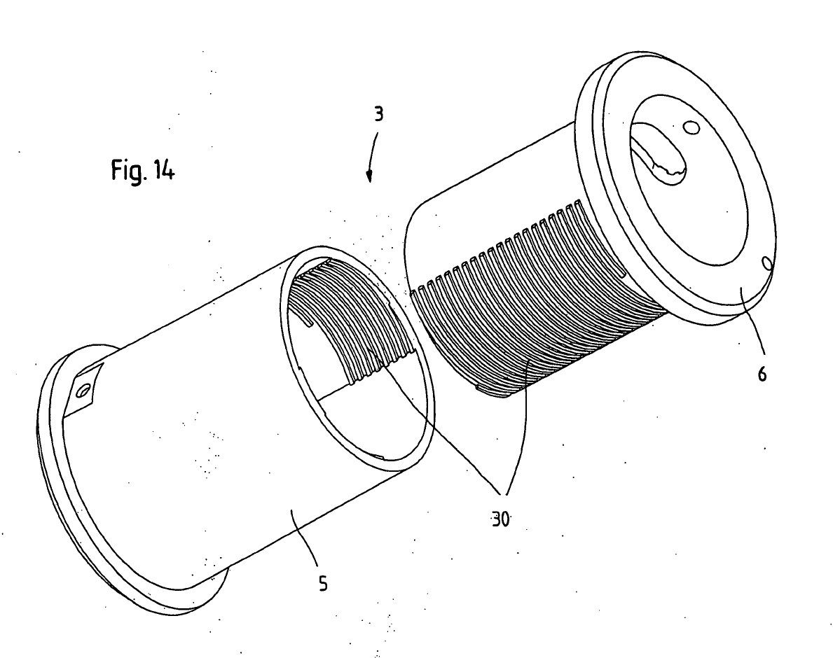

FIG. 14 a view of the housing of the pin-type lock according to a second embodiment.

Also in the following description the terms “inside” and “outside” still refer to the lockable room.

The pin-type lock (1) according to the invention is illustrated in the FIGS. 1 to 14, a first embodiment being shown in the FIGS. 1 to 7 and a second embodiment in the FIGS. 8 to 14.

In the open or unlocked condition of the pin-type lock (1) as shown in the FIGS. 1, 2 and 7, the locking pin (2) is in an outwardly pushed position within the housing (3). For closing the sliding door the same is moved into the passageway, whereupon the locking pin (2) is pushed from the outside to the inside, as shown in the FIGS. 3 and 4, whereby the locking pin (2) locks against the door frame inner surface situated in the lockable room and thus locks the sliding door. In this position, the garter spring (4) engages in the groove (7) on the outer periphery of the outer housing part (5) and secures the inner locking pin (8) against possible break-in attempts via the sealing gap. In such a case and without this safeguard, the locking pin (8) could easily be pushed outwards to cause unlocking of the sliding door.

Up to this point of time the locking pin (2) is in its non-separated condition, as shown in the FIGS. 1 to 4. For separating the locking pin (2) to form a thermally insulated intermediate space, the handle (10) here shown as a recess on the outer part (9) of the locking pin is grasped to pull the outer part (9) of the locking pin again outwards, thus causing a separation of the locking pin (2). The outer part (9) of the locking pin is pulled outwards as far as permitted by the guidance of the guiding element (11) attached to the outer part (9) of the locking pin in the housing groove (12) and until the clamping element (13) engages in the recess (14) provided on the inner periphery of the outer housing part (9), which is situated on the outside, thus locking this position of the outer part (9) of the locking pin.

For opening the lockable room, the clamping element (13) is first pushed radially inwards, whereby the pressure spring (20) is compressed. The outer part (9) of the locking pin is thus released from its locked condition and can again be displaced from the outside to the inside until it contacts the inner part (8) of the locking pin. Then the key is inserted in the profile cylinder (21) and turned in a clockwise direction, thus causing a coupling element (15) to be caught by a locking cam not shown. The inner part (8) of the locking pin and the outer part (9) of the locking pin are thus rigidly connected to each other and can jointly be pulled outwards by pulling the handle (10) to unlock the sliding door.

In case a person is inadvertently locked or in any other case of emergency, the invention provides for an emergency opening of the door from inside of the locked room. To this end the inner part (8) of the locking pin is coupled to a pin (16), which is centrally supported in the part (8) of the locking pin for displacement towards the same, as shown in the FIGS. 2 and 4. On its inner side the pin (16) is rigidly connected to a disk (17). Pushing the mushroom head (18), which serves as an operating element, from inside causes the pressure spring (19) to be compressed, thus forming an intermediate space between the disk (17) and the inner part (8) of the locking pin for accommodating the expanding garter spring (4). Thus the groove (7) in the outer housing part (5) is cleared again and the inner part (8) of the locking pin becomes freely movable for being pushed from the inside to the outside, thus unlocking the sliding door. The distance of displacement of the disk (17) is limited here by the guidance of the guide element (22) in the housing groove (12), and this guidance simultaneously secures the disk (17) against rotation in the housing (3).

Also the housing (3) is secured against rotation in the door leaf, by means of a small plate (23) that is attached to the outer periphery. Further illustrated in the FIGS. 2 and 4 is a packing (24) which is arranged in a groove on the inner periphery of the inner housing part (6) and prevents moisture from penetrating into the housing (3) and disrupting the operation of the lockable pin-type lock (1).

A second and preferred embodiment of the invention is shown in the FIGS. 8 to 14. The housing (3) of this embodiment is composed of two parts (5) and (6), as shown particularly in FIG. 14. The specialty of the housing (3) according to the second embodiment is its telescoping construction. To this end the two parts (5) and (6) of the housing (3) each have a correspondent thread (30), as shown particularly in the illustration of FIG. 14.

However, the respective thread (30) is not continuous as regards both the housing part (5) and the housing part (6). For this reason the two housing parts (5) and (6) can be inserted one into the other, as shown in FIG. 14, and displaced relative to each other in the longitudinal direction, thus allowing the housing (3) to be adapted to differently thick door leaves. For connecting the two housing parts (5) and (6) the same must be rotated relative to each other to cause the respective threads (30) to engage each other. As soon as the threads (30) of the housing parts (5) and (6) are mutually engaged, a permanent and force-transmitting connection between the two housing parts (5) and (6) is established.

The FIGS. 8 and 9 show a constellation of the housing (3) in a position of maximum extension, whereas the FIGS. 10 and 11 show a housing (3) which is adjusted to a minimum concerning its longitudinal extension.

In the second embodiment according to the FIGS. 8 to 14 the inner coupling, i.e. the coupling of the two parts (8) and (9) of the locking pin (2), is accomplished by a long screw (31). The screw (31) is countered by a nut (32). The head of the screw (31) engages in a recess of the outer part (9) of the locking pin, with a ratchet (33) which is formed as an appendix gripping behind the screw head. The ratchet (33) provides a locking surface (35), as shown particularly in the FIGS. 12 and 13.

An opening or unlocking movement in the second embodiment is performed as follows:

A key has to be inserted in the profile cylinder provided by the outer part (9) of the locking pin. This key serves as a sort of handle. In a first step the key has to be turned, thus causing the locking surface (35) provided by the ratchet (33) to engage the head of the screw (31). Thereafter the key has to be pulled, namely outwards in the longitudinal direction of the pin-type lock, i.e. to the left with respect to the drawing in plane e.g. of FIG. 9 or 11. Since the ratchet (33) grips behind the head of the screw (31), also a displacing movement of the screw (31) is caused, namely to the left with respect to the drawing plane in the FIGS. 9 and 11. The lock bar (34) is thus retracted and the locking pin (2) pulled outwards. The factual connection explained above can be learnt particularly from the FIGS. 12 and 13.

For limiting the movement of the inner part (8) of the locking pin a guide element (36) is provided which is formed as a pin, as can be seen especially in the illustration according to FIG. 11. This guide element (36) engages in a recess which is provided in the form of a groove on the inner part (8) of the locking pin.

A ramp (38) cooperating with the lock bar (34) and arranged on the operating element (37) serves to the above-mentioned movement of the lock bar (34).

The lock bar (34) itself is biased by a spring and thus tends to retract inwards, i.e. into the housing (3). The lock bar (34) is designed with a lock bar edge (39), as shown in FIG. 11.

List of reference numbers

| | |
|---|---|
| 1 | lockable pin-type lock |
| 2 | locking pin |
| 3 | cylindrical housing |
| 4 | garter spring |
| 5 | outer housing part |
| 6 | inner housing part |
| 7 | groove in the outer housing part |
| 8 | inner part of locking pin |
| 9 | outer part of locking pin |
| 10 | handle |
| 11 | guide element in the outer part of the locking pin |
| 12 | guide groove in the outer housing part |
| 13 | clamping element |
| 14 | recess on the outer housing part |
| 15 | coupling element |
| 16 | pin |
| 17 | disk |
| 18 | mushroom head of the pin |
| 19 | pressure spring |
| 20 | pressure spring on the clamping element |
| 21 | profile cylinder |
| 22 | guide element on the disk |
| 23 | safeguard against rotation of the housing |
| 24 | packing |
| 25 | clamping element |
| 26 | shoulder on the inner periphery of the outer housing part |
| 27 | bulged portion on the outer housing part |
| 28 | bulged portion on the inner housing part |
| 29 | groove in the inner periphery of the inner housing part |
| 30 | thread |
| 31 | screw |
| 32 | nut |
| 33 | ratchet |
| 34 | lock bar |
| 35 | locking surface |
| 36 | guide element |
| 37 | operating element |
| 38 | ramp |
| 39 | lock bar edge |

1. Lockable pin-type lock for sliding doors, with a cylindrical housing which can be fastened in the door leaf, and with a two-part locking pin which can be displaced in the axial direction in the housing, wherein the two parts of the locking pin can be displaced relative to each other in order to form an intermediate space.

2. Lockable pin-type lock according to claim 1, wherein the two parts of the locking pin include a separation vertically to the axial direction.

3. Lockable pin-type lock according to claim 1, wherein outer part of the locking pin includes a profile cylinder.

4. Lockable pin-type lock according to claim 1, wherein the outer part of the locking pin includes a clamping device.

5. Lockable pin-type lock according to claim 1, wherein the cylindrical housing is composed of two housing parts.

6. Lockable pin-type lock according to claim 1, wherein the two housing parts are constructed so as to be telescoping.

7. Lockable pin-type lock according to claim 1, wherein the inner part of the locking pin includes a groove which is situated on its inner periphery.

8. Lockable pin-type lock according to claim 7, wherein a packing is provided in the groove of the inner part (8) of the locking pin.

9. Lockable pin-type lock according to claim 1, wherein a lock bar which can be displaced transversely to the locking pin.

10. Lockable pin-type lock according to claim 1, wherein a screw coupling the two parts of the locking pin to each other.
